(19) United States
(12) Patent Application Publication
(10) Pub. No.: US 2019/0330970 A1
(43) Pub. Date: Oct. 31, 2019

(54) Method and System of Cement Bond Evaluation by Non-Stationary Acoustic Waves

(71) Applicant: GOWell International, LLC, Houston, TX (US)

(72) Inventors: Jiajun Zhao, Houston, TX (US); Qinshan Yang, Katy, TX (US); Jinsong Zhao, Houston, TX (US)

(73) Assignee: GOWell International, LLC, Houston, TX (US)

(21) Appl. No.: 15/962,642

(22) Filed: Apr. 25, 2018

(51) Int. Cl. E21B 47/00; E21B 47/18; G01V 1/50

(52) U.S. Cl. CPC E21B 47/0005; G01V 1/50; E21B 47/18

(57) ABSTRACT

A method and system for inspecting cement downhole. The method may comprise inserting an inspection device inside a casing. The inspection device may comprise a transducer, a micro-controller unit, an information handling system, and a centralizing module. The method may further comprise activating the transducer, wherein the transducer generates a non-stationary acoustic wave, determining a measurement using the inspection device, and generating an estimated cement impedance output using at least the measurement and data corresponding to the impedance and inner diameter of a casing and the impedance of the transducer.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

### Field of the Disclosure

This disclosure relates to a field for a downhole tool that may be capable of detecting in cement, bad interfaces between casing and cement, and/or bad interfaces between cement and a formation. Processing recorded non-stationary acoustic waves may help identify properties within cement attached to casing.

### Background of the Disclosure

Downhole casing may be surrounded and/or encased by cement. It may be beneficial to evaluate the interface between the casing and the cement. Previous methods for inspecting cement have come in the form of non-destructive inspection tools that may transmit acoustic waves that may be reflected and recorded for analysis. Previous methods may not be able to perform measurements of the interface between casing and cement using non-stationary acoustic waves.

Currently, determining cement impedance to evaluate cement bonds downhole has several obstacles. For example, different types of transducers for generating acoustic waves are required depending on the specific casing thickness. Further, determining properties of borehole fluids may require multiple transmitter/receiver setups in order to take different types of measurements. A transducer that generates non-stationary acoustic waves for cement bond evaluation, on the other hand, may cover a broad range of casing thickness, which eliminates the need to select different transducers. Non-stationary acoustic waves also provide a better signal-to-noise ratio, make filtering a single complete reflection trail possible, and improve spectral resolution. Also, cement bond evaluation based on a complete reflection trail is insensitive to eccentering between transducers and casing.

### BRIEF SUMMARY OF SOME OF THE PREFERRED EMBODIMENTS

These and other needs in the art may be addressed in embodiments by a device and method for evaluating cement bonds using non-stationary acoustic waves.

A method and system for inspecting cement downhole. The method may comprise inserting an inspection device into a wellbore. The inspection device may comprise a transducer, a micro-controller unit, an information handling system, and a centralizing module. The method may further comprise activating the transducer, wherein the transducer generates a non-stationary acoustic wave, determining a measurement using the inspection device, and generating an estimated cement impedance output using at least the measurement and data corresponding to the impedance and inner diameter of a casing and the impedance of the transducer.

A method and system for inspecting cement downhole. The method may comprise inserting an inspection device into a wellbore. The inspection device may comprise a transducer, a micro-controller unit, an information handling system, and a controller. The method may further comprise determining a measurement using the inspection device and generating an estimated cement impedance output using at least the measurement and data corresponding to the impedance and inner diameter of a casing and the impedance of the transducer.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other embodiments for carrying out the same purposes of the present invention. It should also be realized by those skilled in the art that such equivalent embodiments do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates an embodiment of an inspection system disposed downhole.

FIG. 2a illustrates a waveform of a non-stationary chirp signal.

FIG. 2b illustrates a waveform of a windowed chirp signal.

FIG. 2c illustrates a waveform of multiple reflection trails.

FIG. 3 illustrates a spectrogram with two signals.

FIG. 4 illustrates a time-domain signal.

FIG. 5 illustrates a frequency-domain signal with its envelope of data points.

FIG. 6 illustrates graphs reflecting the relationship of theoretical impedance behind casing to Q and DipDepth.

FIG. 7 illustrates graphs reflecting the relationship of theoretical impedance behind casing to Q and DipDepth with calibrated and actual measurements.

### DETAILED DESCRIPTION OF THE PREFERRED EMBODIMENTS

The present disclosure relates to embodiments of a device and method for inspecting and detecting properties of cement attached to casing. More particularly, embodiments of a device and method are disclosed for evaluating cement bonds surrounding casing. In embodiments, an inspection device may generate non-stationary acoustic waves in surrounding casing and cement. In embodiments, a transducer generates non-stationary acoustic waves.

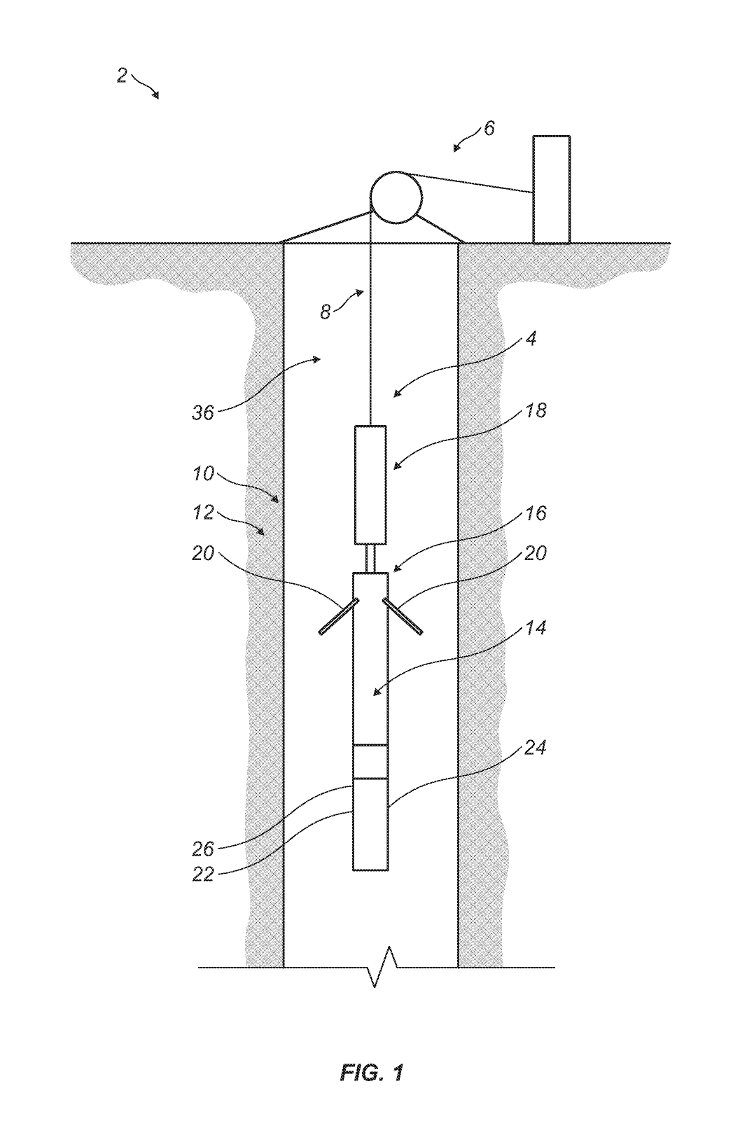

FIG. 1 illustrates an inspection system 2 comprising an inspection device 4 and a service device 6. In embodiments, inspection device 4 and service device 6 may be connected by a tether 8. Tether 8 may be any suitable cable that may support inspection device 4. A suitable cable may be steel wire, steel chain, braided wire, metal conduit, plastic conduit, ceramic conduit, and/or the like. A communication line, not illustrated, may be disposed within tether 8 and connect inspection device 4 with service device 6. Without limitation, inspection system 2 may allow operators on the surface to review recorded data in real time from inspection device 4.

In embodiments, inspection device 4 may be inserted into a casing 10. In further embodiments, there may be a plurality of casing 10. Inspection device 4, as illustrated in FIG. 1, may be able to determine the location of aberrations within a cement 12, which may comprise inadequate casing 10 and cement 12 adhesion, inadequate cement 12 and formation (not illustrated) adhesion, cracks in cement 12, and/or the like.

FIG. 1 further illustrates inspection device 4 comprising a transducer 14, a centralizing module 16, and a telemetry module 18. In embodiments, as shown, transducer 14 may be disposed below centralizing module 16 and telemetry module 18. In other embodiments, not illustrated, transducer 14 may be disposed above and/or between centralizing module 16 and telemetry module 18.

In embodiments, transducer 14 may generate non-stationary acoustic waves. The term “non-stationary” refers to signals that have parameters such as mean and variance change over time. Further, in embodiments, transducer 14 may generate non-stationary broadband waves. The term “broadband” refers to a band with a wide range of frequencies. In embodiments, the broadband range of frequencies is 0 kHz to 800 kHz. In embodiments, any type of non-stationary broadband acoustic wave may be generated by transducer 14 for the purpose of determining the borehole fluid properties of density and speed of sound. Examples of broadband acoustic waves include, but are not limited to, chirp signals, train signals, Gaussian signals, and sinc signals. Further, broadband acoustic waves may be categorized as either low crest factor or high crest factor. The term “crest factor” refers to the ratio of the peak value to the effective value of any periodic quantity such as a sinusoidal alternating current. In embodiments, transducer 14 may emit non-stationary broadband acoustic waves, and transducer 14 may also receive overlapping signal reflections, referred to as multiple reflection trails 34. Further, in embodiments, the head of transducer 14 may not need to be changed even if the inner diameter of casing 10 changes.

As also illustrated in FIG. 1, centralizing module 16 may be used to position inspection device 4 inside casing 10. In embodiments, centralizing module 16 laterally positions inspection device 4 at about a center of casing 10. Centralizing module 16 may be disposed at any location above and/or below transducer 14. In embodiments, centralizing module 16 may be disposed above transducer 14 and below telemetry module 18. Centralizing module 16 may comprise one or more arms 20. In embodiments, there may be a plurality of arms 20 that may be disposed at any location along the exterior of centralizing module 16. Specifically, arms 20 may be disposed on the exterior of centralizing module 16. In an embodiment, as shown, at least one arm 20 may be disposed on opposing lateral sides of centralizing module 16. Additionally, there may be at least three aims 20 disposed on the outside of centralizing module 16. Arms 20 may be moveable at about the connection with centralizing module 16, which may allow the body of arm 20 to be moved closer and/or farther away from centralizing module 16. Arms 20 may comprise any suitable material. Suitable material may be, but is not limited to, stainless steel, titanium, metal, plastic, rubber, neoprene, and/or any combination thereof. In other embodiments, not illustrated, inspection device 4 may employ a standoff instead of centralizing module 16. In embodiments, the purpose of centralizing module 16 is to prevent bumping inspection device 4 given that eccentering between transducer 14 and casing 10 is not a concern.

Telemetry module 18, as illustrated in FIG. 1, may comprise any devices and processes for making, collecting, and/or transmitting measurements. For instance, telemetry module 18 may comprise an accelerator, gyro, and the like. In embodiments, telemetry module 18 may operate to indicate where inspection device 4 may be disposed within casing 10. Telemetry module 18 may be disposed at any location above or below transducer 14. In embodiments, telemetry module 18 may send information through the communication line in tether 8 to a remote location such as a receiver or an operator in real time, which may allow an operator to know where inspection device 4 may be located within casing 10. In embodiments, telemetry module 18 may be centered about laterally in casing 10. Alternatively, in embodiments, telemetry module 18 may not be needed when data is processed downhole by inspection device 4.

As illustrated in FIG. 1, a micro-controller unit 22 may be disposed within inspection device 4. In embodiments, micro-controller unit 22 may store all received, recorded, and measured data and may transmit the data in real time through a communication line in tether 8 to a remote location such as an operator on the surface. In embodiments, data may include, but not be limited to, impedance of transducer 14, impedance of casing 10, and inner diameter of casing 10. Micro-controller unit 22 may comprise flash chips and/or RAM chips, which may be used to store data and/or buffer data communication. Additionally, micro-controller unit 22 may further comprise a transmitter, processing unit and/or a microcontroller. In embodiments, micro-controller unit 22 may be removed from inspection device 4 for further processing. Micro-controller unit 22 may be disposed within any suitable location on inspection device 4 such as about the top, about the bottom, or about the center of inspection device 4. In embodiments, micro-controller unit 22 may be in communication with a controller 24 by any suitable means such as a communication line.

In embodiments, an information handling system 26, discussed in further detail below, may be disposed in inspection device 4 and communicate with micro-controller unit 22 through tether 8. Information handling system 26 may analyze recorded non-stationary waves to determine an estimated impedance of cement 12. In embodiments, information handling system 26 may be disposed within inspection device 4 and may transmit information through tether 8 to service device 6.

Without limitation, information handling system 26 may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, information handling system 26 may be a personal computer, a network storage device, or any other suitable device and may vary in size, shape, performance, functionality, and price. Information handling system 26 may include random access memory (RAM), one or more processing resources such as a central processing unit (CPU) or hardware or software control logic, ROM, and/or other types of nonvolatile memory. Additional components of information handling system 26 may include one or more disk drives, one or more network ports for communication with external devices as well as various input and output (I/O) devices, such as a keyboard, a mouse, and a video display. Information handling system 26 may also include one or more buses operable to transmit communications between the various hardware components.

Controller 24, as illustrated in FIG. 1, may control transducer 14. Controller 24 may be pre-configured at the surface to take into account the downhole logging environment and specific logging cases, which may be defined as a static configuration. It may also be dynamically configured by what transducer 14 may record. Controller 24 may be disposed at any suitable location on inspection device 4. In embodiments, such disposition may be about the top, about the bottom, or about the center of inspection device 4.

Service device 6 may comprise a mobile platform (e.g., a truck) or stationary platform (e.g., a rig), which may be used to lower and raise inspection device 4. In embodiments, service device 6 may be attached to inspection device 4 by tether 8. Service device 6 may comprise any suitable equipment that may lower and/or raise inspection device 4 at a set or variable speed, which may be chosen by an operator. The movement of inspection device 4 may be monitored and recorded by telemetry module 18.

In embodiments, a calibration test may be conducted initially based on the configuration of casing 10 and water behind casing 10 rather than cement 12 behind casing 10. This type of calibration test is referred to as a “free pipe test,” which indicates that casing 10 is not fixed by cement 12. In embodiments, other parameters such as the material properties and geometry of casing 10 are the same.

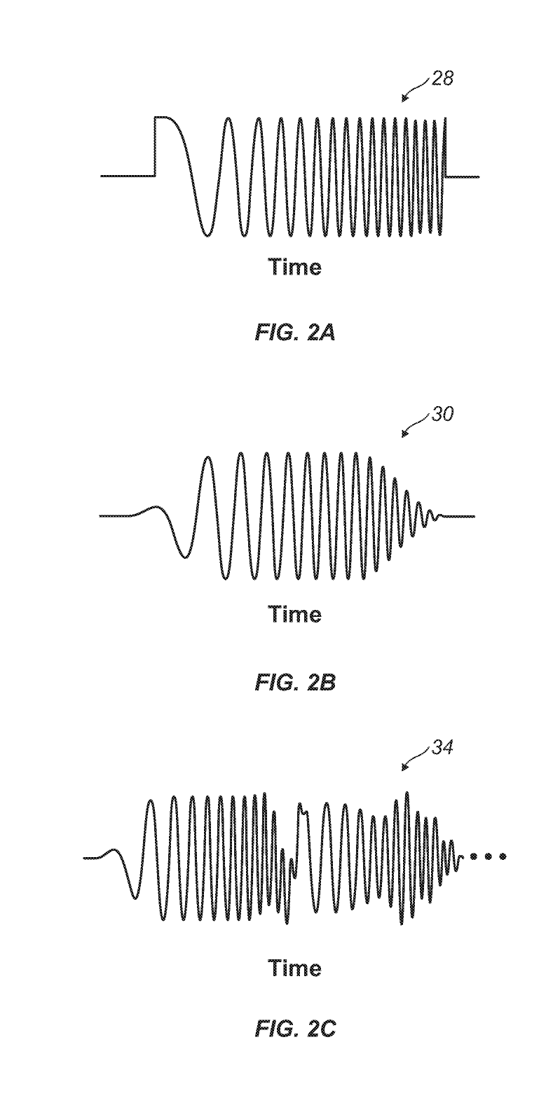

In embodiments, a first step of using non-stationary acoustic waves to evaluate cement bonds may be generating a non-stationary acoustic wave using transducer 14. In embodiments, a chirp signal 28 may be generated by transducer 14. Chirp signal 28 is an example of a non-stationary acoustic wave with a low crest factor, and the waveform of exemplar chirp signal 28 is shown in FIG. 2a. Although certain embodiments refer to chirp signal 28, non-stationary acoustic waves are not limited to chirp signals.

In embodiments, a second step of evaluating cement bonds may be windowing the non-stationary acoustic wave. In embodiments, chirp signal 28 is windowed. In signal processing, a window function is a mathematical function that is zero-valued outside of some chosen interval. The result of chirp signal 28 being windowed is that it tapers at the end as shown in FIG. 2b.

As shown in FIG. 2b, in embodiments, windowed chirp signal 28, hereinafter referred to as an input signal 30, is emitted from transducer 14. In embodiments, input signal 30 has a low crest factor over a much longer time period than a pulse, which provides a better signal/noise ratio. For example, in embodiments, input signal 30 has an evenly distributed amplitude whereas a pulse signal's amplitude is significantly reduced after the initial burst. In other applications, a pulse signal may be separated into two parts. The first part includes a relatively high-amplitude portion of the pulse signal followed by a second part that has a relatively low-amplitude portion of the pulse signal. A decision is made to separate the two parts of the pulse signal into the dominant frequency (relatively high-amplitude portion) and resonant frequency (relatively low-amplitude portion). The resonant frequency portion may also be referred to as the resonant window. The determination where to split the pulse signal into the dominant frequency and resonant frequency may have a significant impact on measurements based on the pulse signal. In embodiments, the entire reflection of input signal 30 is used for measurement so there is no need to separate input signal 30 into two parts. In embodiments, input signal 30 has a dominant frequency that is location dependent, which makes filtering a single complete reflection trail possible even though there may be overlap between neighboring reflections.

In embodiments, a third step of evaluating cement bonds may be transducer 14 receiving an output signal (not illustrated). In embodiments, the output signal (not illustrated) contains overlapping signal reflections, referred to as multiple reflection trails 34, as shown in FIG. 2c. In embodiments, the multiple reflection trails 34 are multipole reflection trails.

In embodiments, a fourth step of evaluating cement bonds may be determining the decay trend of multiple reflection trails 34 using information handling system 26. In embodiments, the decay trend of multiple reflection trails 34 is used for estimating the properties of borehole fluids 36, as shown in FIG. 1, which makes unnecessary having additional measurements by other transmitter-receiver setups.

In embodiments, a fifth step of evaluating cement bonds may be employing the decay trend of multiple reflection trails 34, the impedance of casing 10, and the impedance of transducer 14 to determine the impedance of borehole fluids 36. In embodiments, micro-controller unit 22 may store the impedance of casing 10 and the impedance of transducer 14 as known parameters. In acoustics, impedance is the product of velocity times density, also called acoustic impedance. In embodiments, the information handling system 26 may use the following formula to determine the impedance of borehole fluids 36:

R=(ζ₂−ζ₁)/(ζ₂+ζ₁)

R represents the reflection coefficient from medium 2 to medium 1. ζ₁ represents the acoustic impedance of borehole fluids 36 to be determined, and ζ₂ represents the acoustic impedance of casing 10, which is a known parameter. R may be determined from the decay trend of multiple reflection trails 34, and thus, ζ₁ may be determined.

In embodiments, a sixth step of evaluating cement bonds may be information handling system 26 determining the density of borehole fluids 36 and the speed of sound in borehole fluids 36 using the impedance of borehole fluids 36 and the inner diameter of casing 10. The inner diameter of casing 10 is a known parameter and may be input into micro-controller unit 22 prior to running the calibration test.

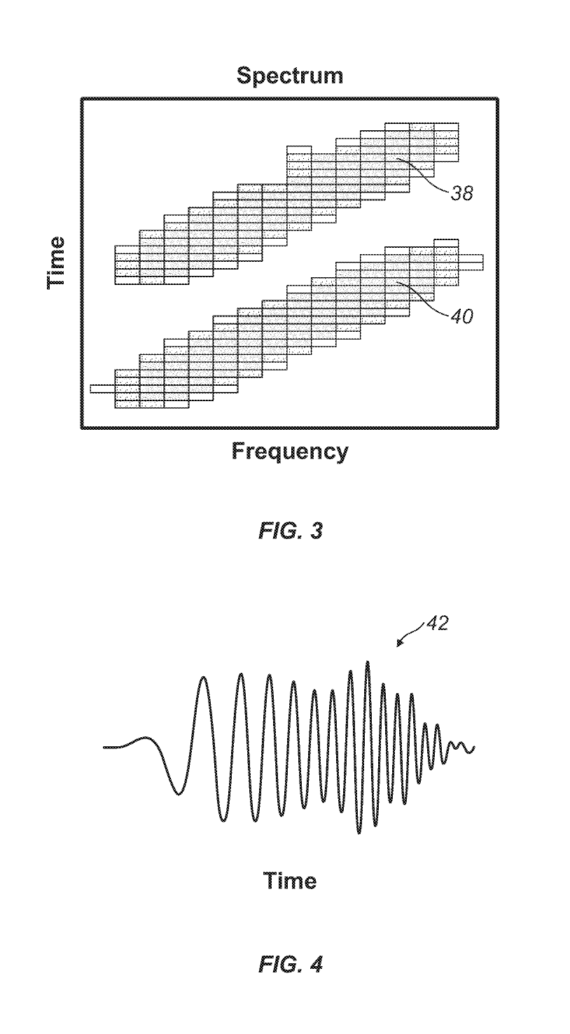

In embodiments, a seventh step of evaluating cement bonds may be information handing system 26 applying a short-time Fourier transform to multiple reflection trails 34. A short-time Fourier transform is a Fourier-related transform used to determine the sinusoidal frequency and phase content of local sections of a signal as it changes over time. The procedure calls for dividing a longer time signal into shorter segments of equal length and then determining the Fourier transform separately on each shorter segment. This reveals the Fourier spectrum on each shorter segment. The result may be shown in a spectrogram (time vs. frequency). FIG. 3 shows a spectrogram, wherein a first signal 38 and a second signal 40 each represents a single reflection trail. Thus, the Fourier transform breaks multiple reflection trails 34 into first signal 38 and second signal 40 as shown in FIG. 3. In embodiments, input signal 30 has a dominant frequency that is location dependent, which makes filtering a single complete reflection trail possible even though there is overlap between neighboring reflections. In embodiments, input signal 30 may comprise a time period longer than the round-trip sound traveling time between transducer 14 and the inner wall of casing 10, which improves the spectral resolution.

In embodiments, an eighth step of evaluating cement bonds may be information handling system 26 applying a time-adaptive filter to isolate first signal 38 as shown in FIG. 3. Essentially, the short-time Fourier transform and the time-adaptive filter are implemented to separate a complete reflection trail from the overlapped reflection trail sequence.

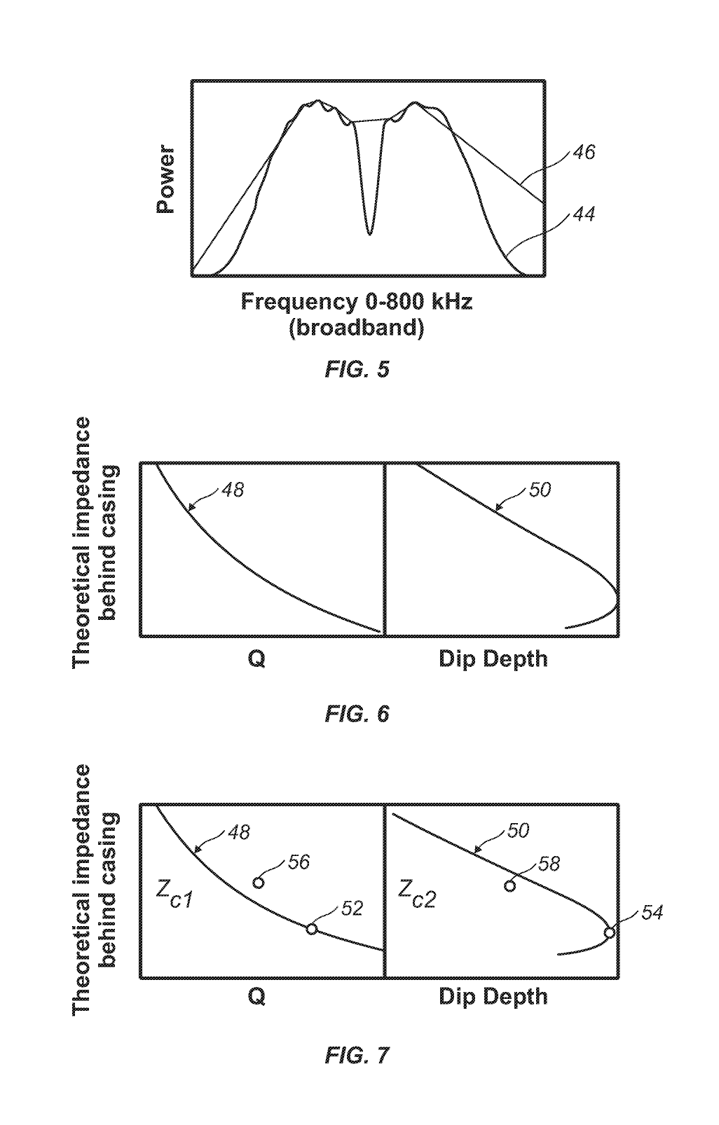

In embodiments, a ninth step of evaluating cement bonds may be extracting a single and complete reflection trail. This involves converting a time-domain signal 42 as shown in FIG. 4 to a frequency-domain signal 44 as shown in FIG. 5. A time-domain graph shows how a signal changes over time, whereas a frequency-domain graph shows how much of the signal lies within each given frequency over a range of frequencies. Most products currently on the market use only time domain. The benefit of frequency domain is that it has a better tolerance for strong noise, which can drown out the resonance window reading.

In embodiments, a tenth step of evaluating cement bonds may be determining the spectrum of frequency-domain signal 44 and an envelope 46 of data points, as shown in FIG. 5, using information handling system 26. FIG. 5 shows power in relation to broadband frequency.

In embodiments, an eleventh step of evaluating cement bonds may be determining a measured quality factor (“Q”) and a resonance strength (“DipDepth”). Measured quality factor Q is the frequency-to-bandwidth ratio of the resonator:

$$Q {}^{def} \frac{fr}{Δ f} = \frac{{ω}_{r}}{Δω}$$

The term fᵣ is the resonant frequency (the location of the dip at the power spectrum in FIG. 5). The Δf is the resonance width or full width at half minimum (“FWHM”), i.e., the bandwidth below which the power is smaller than half the power at the resonant frequency. The ωᵣ=2πfᵣ, which is the angular resonant frequency. The Δω is the angular half-power bandwidth. DipDepth, as the resonance strength, is the depth of the dip at the spectrum in FIG. 5. In embodiments, as shown in FIG. 5, the deeper the dip, the stronger the resonance or the vibration of casing 10, which indicates the thickness of casing 10. Likewise, in embodiments, the shallower the dip, the weaker the resonance or the vibration of casing 10.

In embodiments, a twelfth step of evaluating cement bonds may be preparing a three-interface model with the density of borehole fluids 36 and the speed of sound in borehole fluids 36 as well as the thickness of casing 10.

$$R = \frac{( 1 - \frac{{Z}_{1}}{{Z}_{3}} ) cos {k}_{2} h + j ( \frac{{Z}_{2}}{{Z}_{3}} - \frac{{Z}_{1}}{{Z}_{2}} ) sin {k}_{2} h}{( 1 + \frac{{Z}_{1}}{{Z}_{3}} ) cos {k}_{2} h + j ( \frac{{Z}_{2}}{{Z}_{3}} + \frac{{Z}_{1}}{{Z}_{2}} ) sin {k}_{2} h}$$

In embodiments, and for purposes of the formula above, it is assumed that the acoustic waves move from borehole fluids 36 (medium 1) to casing 10 (medium 2), and to cement 12 (medium 3). Further, terms Z₁, Z₂, and Z₃ are the theoretical acoustic impedances of borehole fluids 36 (medium 1), casing 10 (medium 2), and cement 12 (medium 3), respectively. Additionally, term k₂ represents the wavenumber in casing 10 (medium 2), which is defined as the ratio of angular frequency to speed of sound in casing 10 (medium 2); term h represents the thickness of casing 10; term j represents the imaginary unit number; and lastly, term R represents the reflection coefficient, which is the ratio of the reflected sound pressure to the incident sound pressure in borehole fluids 36 (medium 1). FIG. 6 shows the theoretical impedance behind casing 10 compared to values for Q, a first curve 48, and compared to values for DipDepth, a second curve 50.

In embodiments, a thirteenth step of using broadband acoustic waves to evaluate cement bonds may be normalizing the measurements. In FIG. 7, there may be the first curve 48 representing the relationship between the acoustic impedance behind casing 10 and the quality factor, Q, and the second curve 50 representing the relationship between the acoustic impedance behind casing and the DipDepth. Within the graphs in FIG. 7, point 52 is the calibration test measurement of Q, and point 54 is the calibration test measurement of DipDepth. Further, point 56 is the actual measurement of Q, and point 58 is the actual measurement of DipDepth. Initially, in embodiments, the calibration test measurement of Q is plotted on the graph in FIG. 7 and adjusted to eliminate the discrepancy with the theoretical curve 48. Similarly, the calibration test measurement for DipDepth is plotted on the graph in FIG. 7 and adjusted to eliminate the discrepancy with the theoretical curve 50. Next, in embodiments, the actual measurement of Q, point 56, is adjusted based on the following normalization by calibration formula to provide a value represented by Z_{c1}:

X_{calibrated}=X_{water,calibrated}/X_{water}*X

Further, the actual measurement of DipDepth, point 58, is adjusted based on the normalization by calibration formula above to provide a value represented by Z_{c2}.

In embodiments, a fourteenth step of using broadband acoustic waves to evaluate cement bonds may be determining the estimated cement impedance using the following formula:

Estimated Cement Impedance=0.5*(Z_{c1}+Z_{c2})

This formula to determine estimated cement impedance requires the calibrated acoustic impedance inferred from the plot of impedance against Q, Z_{c1}, and the calibrated acoustic impedance inferred from the plot of impedance against DipDepth, Z_{c2}.

Certain examples of the present disclosure may be implemented at least in part with non-transitory computer-readable media. For the purposes of this disclosure, non-transitory computer-readable media may include any instrumentality or aggregation of instrumentalities that may retain data and/or instructions for a period of time. Non-transitory computer-readable media may include, for example, without limitation, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such as wires, optical fibers, microwaves, radio waves, and other electromagnetic and/or optical carriers; and/or any combination of the foregoing.

Although the present invention and its advantages have been described in detail, it should be understood that various changes, substitutions and alterations may be made herein without departing from the spirit and scope of the invention as defined by the appended claims.

1. A method for inspecting cement downhole comprising:
inserting an inspection device into a wellbore penetrating a subterranean formation wherein the inspection device comprises:
a transducer;
a micro-controller unit configured to store at least data corresponding to the impedance and inner diameter of a casing and the impedance of the transducer;
an information handling system coupled to the micro-controller unit; and
a centralizing module;
activating the transducer, wherein the transducer generates a non-stationary acoustic wave;
determining a measurement of quality factor and resonance strength using the inspection device; and
generating an estimated cement impedance output using at least the measurement and the data corresponding to the impedance and inner diameter of a casing and the impedance of the transducer.

2. The method of claim 1, wherein the step of inserting the inspection device comprises inserting the inspection device into a casing.

3. The method of claim 1, wherein the inspection device further comprises a telemetry module.

4. The method of claim 1, wherein the inspection device further comprises a controller.

5. The method of claim 1, wherein the non-stationary acoustic wave comprises a broadband acoustic wave.

6. The method of claim 5, wherein the frequency range of the broadband acoustic wave is 0 kHz to 800 kHz.

7. The method of claim 5, wherein the broadband acoustic wave comprises a chirp signal.

8. The method of claim 1, wherein the method further comprises determining a calibration measurement using the inspection device.

9. A method for inspecting concrete downhole comprising:
inserting an inspection device into a wellbore penetrating a subterranean formation wherein the inspection device comprises:
a transducer;
a micro-controller unit configured to store at least data corresponding to the impedance and inner diameter of a casing and the impedance of the transducer;
an information handling system coupled to the micro-controller unit; and
a controller.
determining a measurement of quality factor and resonance strength using the inspection device; and
generating an estimated cement impedance output using at least the measurement and the data corresponding to the impedance and inner diameter of a casing and the impedance of the transducer.

10. The method of claim 9, wherein the step of inserting the inspection device comprises inserting the inspection device into a casing.

11. The method of claim 9, wherein the inspection device further comprises a centralizing module.

12. The method of claim 9, wherein the inspection device further comprises a telemetry module.

13. The method of claim 9, wherein the method further comprises activating the transducer, wherein the transducer generates a non-stationary acoustic wave.

14. The method of claim 13, wherein the non-stationary acoustic wave comprises a broadband acoustic wave.

15. The method of claim 14, wherein the frequency range of the broadband acoustic wave is 0 kHz to 800 kHz.

16. The method of claim 14, wherein the broadband acoustic wave comprises a chirp signal.

17. The method of claim 9, wherein the method further comprises determining a calibration measurement using the inspection device.
